(19) United States
(12) Patent Application Publication
(10) Pub. No.: US 2017/0114238 A1
(43) Pub. Date: Apr. 27, 2017

(54) AQUEOUS INK-JET INK COMPRISING AN ANTIFOAMING AGENT

(71) Applicant: E I DU PONT DE NEMOURS AND COMPANY, Wilmington, DE (US)

(72) Inventor: Samit N. Chevli, Hockessin, DE (US)

(21) Appl. No.: 15/314,570

(22) PCT Filed: May 29, 2015
(86) PCT No.: PCT/US2015/033138

§ 371 Date: Nov. 29, 2016

Related U.S. Application Data
(60) Provisional application No. 62/004,432, filed on May 29, 2014.

(51) Int. Cl. C09D 11/326; B41J 2/01; C09D 11/033; C09D 11/38; C09D 11/102

(52) U.S. Cl. CPC C09D 11/326; C09D 11/38; C09D 11/102; C09D 11/033; B41J 2/01

(57) ABSTRACT

The present disclosure provides an ink for inkjet printing. The ink contains an aqueous vehicle, a colorant and an effective amount of an antifoaming agent. The antifoaming agent is an acetylenic glycol which is not a surfactant.

### CROSS REFERENCE TO RELATED APPLICATIONS

This application claims priority under 35 U.S.C. §119 from U.S. Provisional Application Ser. No. 62/004432, filed May 29, 2014, which is incorporated by reference in its entirety.

### BACKGROUND OF THE DISCLOSURE

This disclosure pertains to an aqueous inkjet ink, in particular to an aqueous inkjet ink comprising an aqueous vehicle, a pigment colorant and an antifoaming agent.

Inkjet printing is a non-impact printing process in which droplets of ink are deposited on a substrate, such as paper, to form the desired image. Inkjet printers are equipped with an ink set which, for full color printing, typically comprises a cyan, magenta and yellow ink (CMY). An ink set also commonly comprises a black ink (CMYK).

Since the inception of inkjet printing, the technology has evolved tremendously in the past three decades. Ink-jet printing technology is now not just confined to desk top printers, but used to build digital web presses for printing transactional and promotional material, books, magazines, etc. A key area of development for digital web presses is to print faster. One way to accomplish faster printing is to fire ink drops from an ink-jet printhead at a higher frequency. With the piezo printheads, printing at higher frequency requires an ink to be degassed so that the inks can jet reliably. Degassing inks increases the cost of the ink itself or increases the cost of digital web press printing process.

Additional requirements for high frequency inkjet printing include jetting the ink from very small nozzles ranging in diameter from 10-50 microns, having inks with long shelf life (1-2 years) and stable to high temperatures (>50° C.).

U.S. Pat. No. 6,926,766 discloses inks containing a polyalkyl glucoside as a surfactant to improve printing performance.

A need exists for inkjet inks with improved jetting reliability at higher frequency without the need for degassing. The present disclosure satisfies this need by providing compositions having improved jetting performance and higher stability at a high jetting frequency.

### SUMMARY OF THE DISCLOSURE

An embodiment provides an ink-jet ink composition for a high droplet ejection frequency printing system, said composition comprising an aqueous vehicle, a colorant, and an antifoaming agent; wherein said colorant is self-dispersing or dispersed by a polymeric dispersant, and said antifoaming agent is an acetylenic glycol, and wherein said acetylenic glycol is not a surfactant.

Another embodiment provides that the ink is jetted at a frequency greater than 20 KHz.

Another embodiment provides that the ink is jetted at a frequency greater than 30 KHz.

Another embodiment provides that the colorant is a self-dispersing pigment.

Another embodiment provides that the antifoaming agent is present at a concentration range of 0.05%-5% by weight, based on the total weight of ink.

Another embodiment provides that the antifoaming agent is present at a concentration range of 0.1%-0.5% by weight, based on the total weight of ink.

Another embodiment provides that the ink does not contain silica particulates.

Another embodiment provides that the colorant is a pigment dispersed by a polymeric dispersant.

Yet another embodiment provides an aqueous ink-jet ink and an ink-jet printer combination for printing onto a paper substrate, wherein said ink-jet ink comprises an aqueous vehicle, a colorant, and an antifoaming agent, and said ink-jet printer comprises a printhead that does not contain a filter; wherein said colorant is self-dispersing or dispersed by a polymeric dispersant, and said antifoaming agent is an acetylenic glycol, and wherein said acetylenic glycol is not a surfactant.

These and other features and advantages of the present embodiments will be more readily understood by those of ordinary skill in the art from a reading of the following Detailed Description. Certain features of the disclosed embodiments which are, for clarity, described above and below as separate embodiments, may also be provided in combination in a single embodiment. Conversely, various features of the disclosed embodiments that are described in the context of a single embodiment, may also be provided separately or in any subcombination.

### DETAILED DESCRIPTION

Unless otherwise stated or defined, all technical and scientific terms used herein have commonly understood meanings by one of ordinary skill in the art to which this disclosure pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, the term “SDP” means a “self-dispersible” or “self-dispersing” pigment.

As used herein, the term “dispersion” means a two phase system wherein one phase consists of finely divided particles (often in a colloidal size range) distributed throughout a bulk substance, the particles being the dispersed or internal phase and the bulk substance being the continuous or external phase.

As used herein, the term “dispersant” means a surface active agent added to a suspending medium to promote uniform and maximum separation of extremely fine solid particles often of colloidal sizes. For pigments, the dispersants are most often polymeric dispersants, and the dispersants and pigments are usually combined using a dispersing equipment.

As used herein, the term “degree of functionalization” refers to the amount of hydrophilic groups present on the surface of the SDP per unit surface area, measured in accordance with the method described further herein.

As used herein, the term “aqueous vehicle” refers to water or a mixture of water and at least one water-soluble, or partially water-soluble (i.e., methyl ethyl ketone), organic solvent (co-solvent).

As used herein, the term “dyne/cm” means dyne per centimetre, a surface tension unit.

As used herein, the term “cP” means centipoise, a viscosity unit.

As used herein, the term “EDTA” means ethylenediaminetetraacetic acid.

As used herein, the term “IDA” means iminodiacetic acid.

As used herein, the term “EDDHA” means ethylenediamine-di(o-hydroxyphenylacetic acid).

As used herein, the term “DHEG” means dihydroxyethylglycine.

As used herein, the term “DTPA” means diethylenetriamine-N,N,N′,N″,N″-pentaacetic acid.

As used herein, the term “GEDTA” means glycoletherdiamine-N,N,N′,N′-tetraacetic acid.

As used herein, Surfynol® 465 is a surfactant from Air Products and Chemicals (Allentown, Pa., U.S.A.).

As used herein, the term “TEB” means triethyleneglycol monobutyl ether.

As used herein, the term “DBTDL” means dibutyltin dilaurate.

As used herein, the term “IPDI” means isophorone diisocyanate.

As used herein, the term “BMEA” means bis(methoxy ethyl)amine.

As used herein, the term “DMPA” means dimethylol propionic acid.

As used herein, the term “jettability” means good jetting properties with no clogging or deflection during printing.

As used herein, the term “defoamer” is also used to mean an antifoaming agent.

Unless otherwise noted, the above chemicals were obtained from Aldrich (Milwaukee, Wis., U.S.A.) or other similar suppliers of laboratory chemicals.

The materials, methods, and examples herein are illustrative only except as explicitly stated, and are not intended to be limiting.

### Aqueous Vehicle

Selection of a suitable aqueous vehicle mixture depends on requirements of the specific application, such as the desired surface tension and viscosity, the selected colorant, drying time of the ink, and the type of substrate onto which the ink will be printed. Representative examples of water-soluble organic solvents which may be utilized in the present disclosure are those that are disclosed in U.S. Pat. No. 5,085,698.

If a mixture of water and a water-soluble solvent is used, the aqueous vehicle typically will contain about 30% to about 95% of water with the remaining balance (i.e., about 70 to about 5%) being the water-soluble solvent. Compositions of the present disclosure may contain about 60% to about 95% water, based on the total weight of the aqueous vehicle.

The amount of aqueous vehicle in the ink is typically in the range of about 70% to about 99.8%; specifically about 80% to about 99.8%, based on total weight of the ink.

The aqueous vehicle can be made to be fast penetrating (rapid drying) by including surfactants or penetrating agents such as glycol ether(s) or 1,2-alkanediols. Suitable surfactants include ethoxylated acetylene diols (e.g., Surfynols® series from Air Products and Chemicals), ethoxylated primary (e.g., Neodol® series from Shell) and secondary (e.g., Tergitol® series from Union Carbide) alcohols, sulfosuccinates (e.g., Aerosol® series from Cytec), organosilicones (e.g., Silwet® series from Witco) and fluoro surfactants e.g., Zonyl® series from DuPont).

The amount of glycol ether(s) or 1,2-alkanediol(s) added must be properly determined, but is typically in a range of from about 1% to about 15% by weight, and more typically about 2% to about 10% by weight, based on the total weight of the ink. Surfactants may be used, typically in an amount of from about 0.01% to about 5%, and specifically from about 0.2% to about 2%, based on the total weight of the ink.

### Pigments

The term “pigment” as used herein means an insoluble colorant that requires to be dispersed with a dispersant and processed under dispersive conditions in the presence of a dispersant. The colorant also includes dispersed dyes. The dispersion process results in a stable dispersed pigment.

The selected pigment(s) may be used in dry or wet form. For example, pigments are usually manufactured in aqueous media, and the resulting pigments are obtained as a water-wet presscake. In presscake form, the pigment does not agglomerate to the extent it would in dry form. Thus, pigments in water-wet presscake form do not require as much mixing energy to de-agglomerate in the premix process as pigments in dry form. Representative commercial dry pigments are listed in U.S. Pat. No. 5,085,698.

Some examples of pigments with coloristic properties useful in inkjet inks include: cyan pigments from Pigment Blue 15:3 and Pigment Blue 15:4; magenta pigments from Pigment Red 122 and Pigment Red 202, yellow pigments from Pigment Yellow 14, Pigment Yellow 95, Pigment Yellow 110, Pigment Yellow 114, Pigment Yellow 128 and Pigment Yellow 155; red pigments from Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264; green pigments from Pigment Green 1, Pigment Green 2, Pigment Green 7 and Pigment Green 36; blue pigments from Pigment Blue 60, Pigment Violet 3, Pigment Violet 19, Pigment Violet 23, Pigment Violet 32, Pigment Violet 36 and Pigment Violet 38; white pigments such as TiO₂ and ZnO; and black pigment carbon black. The pigment names and abbreviations used herein are the “C.I.” designation for pigments established by Society of Dyers and Colourists, Bradford, Yorkshire, UK and published in The Color Index, Third Edition, 1971.

The pigment of the present disclosure can also be a self-dispersing (or self-dispersible) pigment. The term self-dispersing pigment (or “SDP”) refers to pigment particles whose surface has been chemically modified with hydrophilic, dispersability-imparting groups that allow the pigment to be stably dispersed in an aqueous vehicle without a separate dispersant. “Stably dispersed” means that the pigment is finely divided, uniformly distributed and resistant to particle growth and flocculation.

The SDPs may be prepared by grafting a functional group or a molecule containing a functional group onto the surface of the pigment, by physical treatment (such as vacuum plasma), or by chemical treatment (for example, oxidation with ozone, hypochlorous acid or the like). A single type or a plurality of types of hydrophilic functional groups may be bonded to one pigment particle. The hydrophilic groups are carboxylate or sulfonate groups which provide the SDP with a negative charge when dispersed in aqueous vehicle. The carboxylate or sulfonate groups are usually associated with monovalent and/or divalent cationic counter-ions. Methods of making SDPs are well known and can be found, for example, in U.S. Pat. No. 5,554,739 and U.S. Pat No. 6,852,156.

The SDPs may be black, such as those based on carbon black, or may be colored pigments. Examples of pigments with coloristic properties useful in inkjet inks include: Pigment Blue 15:3 and Pigment Blue 15:4 (for cyan); Pigment Red 122 and Pigment Red 202 (for magenta); Pigment Yellow 14, Pigment Yellow 74, Pigment Yellow 95, Pigment Yellow 110, Pigment Yellow 114, Pigment Yellow 128 and Pigment Yellow 155 (for yellow); Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264 (for red); Pigment Green 1, Pigment Green 2, Pigment Green 7 and Pigment Green 36264 (for green); Pigment Blue 60, Pigment Violet 3, Pigment Violet 19, Pigment Violet 23, Pigment Violet 32, Pigment Violet 36 and Pigment Violet 38 (for blue); and carbon black. However, some of these pigments may not be suitable for preparation as SDP. Colorants are referred to herein by their “C.I.”.

The SDPs of the present disclosure may have a degree of functionalization wherein the density of anionic groups is less than about 3.5μ moles per square meter of pigment surface (3.5 μmol/m²), and more specifically, less than about 3.0 μmol/m². Degrees of functionalization of less than about 1.8 μmol/m², and more specifically, less than about 1.5 μmol/m², are also suitable and may be preferred for certain specific types of SDPs.

The range of useful particle size after dispersion is typically from about 0.005 micrometers to about 15 micrometers. Typically, the pigment particle size should range from about 0.005 micrometers to about 5 micrometers; and, specifically, from about 0.005 micrometers to about 1 micrometers. The average particle size as measured by dynamic light scattering is less than about 500 nm, typically less than about 300 nm.

The amount of pigment present in the ink is typically in the range of from about 0.1% to about 25% by weight, and more typically in the range of from about 0.5% to about 10% by weight, based on the total weight of ink. If an inorganic pigment is selected, the ink will tend to contain higher percentages by weight of pigment than with comparable inks employing organic pigment, since inorganic pigments generally have higher densities than organic pigments.

### Polymeric Dispersant

The polymeric dispersant for the non-self-dispersing pigment(s) may be a random or a structured polymer. Typically, the polymer dispersant is a copolymer of hydrophobic and hydrophilic monomers. The “random polymer” means polymers where molecules of each monomer are randomly arranged in the polymer backbone. For a reference on suitable random polymeric dispersants, see: U.S. Pat. No. 4,597,794. The “structured polymer” means polymers having a block, branched, graft or star structure. Examples of structured polymers include AB or BAB block copolymers such as the ones disclosed in U.S. Pat. No. 5,085,698; ABC block copolymers such as the ones disclosed in EP Patent Specification No. 0556649; and graft polymers such as the ones disclosed in U.S. Pat. No. 5,231,131. Other polymeric dispersants that can be used are described, for example, in U.S. Pat. No. 6,117,921, U.S. Pat. No. 6,262,152, U.S. Pat. No. 6,306,994 and U.S. Pat. No. 6,433,117.

### Antifoaming Agent

A wide variety of surfactants and defoamers is commercially available from Air Products and Chemicals (Allentown, Pa., U.S.A.). While certain acetylenic type of glycols is a surfactant, others are not a surfactant, but rather, a defoamer. The inventor finds that inclusion of an acetylenic type of defoamers in an inkjet ink improves the properties of the ink. Furthermore, inks containing these defoamers do not foam as much and remain stable at high temperatures.

The antifoaming agent is included in the ink in an effective amount to control foaming relative to the same ink without the antifoaming agent. Typically, the antifoaming agent is present in an ink at a level of at least about 0.05% by weight based on the total weight of the ink. The upper level is not limited, but is dictated by considerations such as compatibility with other ink components. In one embodiment, the antifoaming agent is present in a range of 0.05 to 5% based on the total weight of the ink. In another embodiment, the antifoaming agent is present in a range of 0.2% to 0.5% based on the total weight of the ink. The appropriate levels of antifoaming agent can be readily determined by one of ordinary skill in the art through routine experimentation.

### Other Additives

Other ingredients, additives, may be formulated into the inkjet ink, to the extent that such other ingredients do not interfere with the stability and jettability of the inkjet ink. This may be readily determined by routine experimentation by one skilled in the art.

Surfactants are commonly added to inks to adjust surface tension and wetting properties. Suitable surfactants include the ones disclosed in the Vehicle section above. Surfactants are typically used in amounts up to about 5% and more typically in amounts up to 2% by weight, based on the total weight of the ink.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), diethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Polymers may be added to the ink to improve durability or other properties. The polymers can be soluble in the vehicle or in a dispersed form, and can be ionic or nonionic. Soluble polymers include linear homopolymers and copolymers or block polymers. They also can be structured polymers including graft or branched polymers, stars and dendrimers. The dispersed polymers may include, for example, latexes and hydrosols. The polymers may be made by any known process including, but not limited to, free radical, group transfer, ionic, condensation and other types of polymerization. They may be made by a solution, emulsion, or suspension polymerization process. Typical classes of polymer additives include anionic acrylic, styrene-acrylic and polyurethane polymer.

When a polymer is present, its level is typically between about 0.01% and about 3% by weight, based on the total weight of an ink. The upper limit is dictated by ink viscosity or other physical limitations.

### Ink Sets

The term “ink set” refers to all the individual inks or other fluids an inkjet printer is equipped to jet. Ink sets typically comprise at least three differently colored inks. For example, a cyan (C), magenta (M) and yellow (Y) ink forms a CMY ink set. More typically, an ink set includes at least four differently colored inks, for example, by adding a black (K) ink to the CMY ink set to form a CMYK ink set. The magenta, yellow and cyan inks of the ink set are typically aqueous inks, and may contain dyes, pigments or combinations thereof as the colorant. Such other inks are, in a general sense, well known to those of ordinary skill in the art.

In addition to the typical CMYK inks, an ink set may further comprise one or more “gamut-expanding” inks, including differently colored inks such as an orange ink, a green ink, a red ink and/or a blue ink, and combinations of full strength and light strength inks such as light cyan and light magenta. Such other inks are, in a general sense, known to one skilled in the art.

A typical ink set comprises a magenta, yellow, cyan and black ink, wherein the black ink is an ink according to the present disclosure comprising an aqueous vehicle and a self-dispersing carbon black pigment. Specifically, the colorant in each of the magenta, yellow and cyan inks is a dye.

### Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, i.e., driving frequency of the piezo element or ejection conditions for a thermal head for either a drop-on-demand device or a continuous device, and the shape and size of the nozzle. The inks should have excellent storage stability for long periods so as not to clog to a significant extent in an ink jet apparatus. Furthermore, the ink should not corrode parts of the ink jet printing device it comes in contact with, and it should be essentially odorless and non-toxic.

Although not restricted to any particular viscosity range or printhead, the inventive ink set is particularly suited to lower viscosity applications such as those required by thermal printheads. Thus the viscosity of the inventive inks at 25° C. can be less than about 7 cP, typically less than about 5 cP, and more typically than about 3.5 cP. Thermal inkjet actuators rely on instantaneous heating/bubble formation to eject ink drops and this mechanism of drop formation generally requires inks of lower viscosity.

### Substrate

The present embodiments are particularly advantageous for printing on plain paper, such as common electrophotographic copier paper and photo paper, glossy paper and similar papers used in inkjet printers.

### EXAMPLES

Inks were prepared by stirring the indicated ingredients together and filtering the resulting mixture. The water used in the following Examples was deionized unless otherwise stated.

### Dispersion 1

Carbon black (S-160 from Evonik Degussa) was oxidized with ozone according to the process described in U.S. Pat. No. 6,852,156 to create carboxylic acid groups directly attached to the carbon black pigment surface. Potassium hydroxide was used to neutralize the treated pigment and convert the surface acid groups to the potassium salt form. The neutralized mixture was purified by an ultra-filtration to remove free acids, salts, and contaminants. It was further purified by washing repeatedly with de-ionized water until the conductivity of the mixture leveled off and remained relatively constant. After recovery, Dispersion 1 was a 20.5% by weight dispersion of self-dispersing carbon black pigment.

### Paper

The papers used were Canon GF500 (from Canon Inc.), Canon Extra (from Canon Inc.) and Business 4200 (from Xerox Corporation). They are referred to as “Canon GF500”, “Canon Extra” and “Xerox 4200”, respectively. Canon Extra is an all-purpose paper whereas Canon GF500 and Xerox 4200 are more suitable for inkjet printing.

### Optical Density

Inks were printed with a Canon PIXMA iP4200 printer onto the above indicated papers. The coverage that an inkjet printer puts down on a substrate is usually controlled by the printer software and can be set in the printer settings. Printing was done in the selected standard print mode that targets 100% coverage. This setting for 100% coverage means that the inkjet printer is to fire enough droplets/dots to cover at least 100% of the area being printed. This usually results in dots spreading and partially overlapping with each other. The reported optical density (OD) values for areas printed at 100% coverage were measured with a Gretag Macbeth Spectrolino spectrometer manufactured by Gretag-Macbeth AG, Regensdorf, Switzerland.

### Polyurethane Dispersant (IPDI/Terathen650/BMEA)

To a dry, alkali- and acid-free flask equipped with an additional funnel, a condenser and a stirrer, under a nitrogen atmosphere was added Terathane® T-650 (300 g), DMPA (180 g), Sulfolane (876.5 g) and DBTDL (0.12 g). The resulting mixture was heated to 60° C. and thoroughly mixed. To this mixture was added IPDI (437.5 g) via the additional funnel mounted on the flask followed by rinsing any residual IPDI in the additional funnel into the flask with Sulfolane (15 g). The temperature for the reaction mixture was raised to 85° C. and maintained at 85° C. until the isocyanate content reached 0.8% or below. The temperature was then cooled to 60° C. and maintained at 60° C. while BMEA (46 g) was added via the additional funnel over a period of 5 minutes followed by rinsing the residual BMEA in the additional funnel into the flask with Sulfolane (5 g). After holding the temperature for 30 minutes at 60° C., aqueous KOH solution (1755 g, 3% by weight) was added over a period of 10 minutes via the additional funnel followed by de-ionized water (5 g). The mixture was maintained at 60° C. for 1 hr and cooled to room temperature to provide a polyurethane dispersant.

### Polyurethane Binder PU-G (Alanine Terminated IPDI/Terathane1000)

To a dry, alkali- and acid-free flask equipped with an additional funnel, a condenser and a stirrer, under a nitrogen atmosphere was added Terathane® T-1000 (439 g), DMPA (106 g), Sulfolane (463 g) and DBTL (0.20 g). The resulting mixture was heated to 60° C. and thoroughly mixed. To this mixture was added IPDI (299 g) via the additional funnel mounted on the flask followed by rinsing any residual IPDI in the additional funnel into the flask with Sulfolane (20 g). The temperature for the reaction mixture was raised to 85° C. and maintained at 85° C. until the isocyanate content reached 1.0% or below. The reaction mixture was cooled to 60° C., and β-Alanine from Sigma-Aldrich (17.4 g), dissolved in water (75 g) and aqueous 45% KOH (24 g), was added over a period of 5 minutes. After 20 minutes, the polyurethane solution was inverted under high speed mixing by adding a mixture of aqueous 45% KOH (88 g) and water (1904 g). The mixture was maintained at 60° C. for 1 hour and cooled to room temperature to provide a polyurethane solution.

### Preparation of Cyan Pigment Dispersion

The pigmented dispersions used in this invention can be prepared using any conventional milling process known in the art. Most milling processes use a two-step process involving a first mixing step followed by a second grinding step. The first step comprises mixing of all the ingredients, that is, pigment, dispersants, liquid carriers, neutralizing agent and any optional additives to provide a blended “premix”. Typically all liquid ingredients are added first, followed by the dispersants, and lastly the pigment. Mixing is generally done in a stirred mixing vessel, and a high-speed disperser (HSD) is particularly suitable for the mixing step. A Cowels type blade attached to the HSD and operated at from 500 rpm to 4000 rpm, and more typically from 2000 rpm to 3500 rpm, provides optimal shear to achieve the desired mixing. Adequate mixing is usually achieved after mixing under the conditions described above for a period of from 15 to 120 minutes.

The second step comprises grinding of the premix to produce a pigmented dispersion. Typically, grinding involves a media milling process, although other milling techniques can also be used. In the present invention, a lab-scale Eiger Minimill (Model M250, VSE EXP) manufactured by Eiger Machinery Inc., Chicago, Ill. is employed. Grinding was accomplished by charging about 820 grams of 0.5 YTZ® zirconia media to the mill. The mill disk is operated at a speed between 2000 rpm and 4000 rpm, and typically between 3000 rpm and 3500 rpm. The dispersion is processed using a re-circulation grinding process with atypical flow rate through the mill at between 200 to 500 grams/minute, and more typically at 300 grams/minute. The milling may be done using a staged procedure in which a fraction of the solvent is held out of the grind and added after milling is completed. This is done to achieve optimal rheology that maximizes grinding efficiency. The amount of solvent held out during milling varies by dispersion, and is typically between 200 to 400 grams for a batch size with a total of 800 grams. Typically, the dispersions of the present invention are subjected to a total of 4 hours of milling.

Fillers, plasticizers, pigments, carbon black, silica sols, other polymer dispersions and the known leveling agents, wetting agents, antifoaming agents, stabilizers, and other additives known for the desired end use, may also be incorporated into the dispersions.

A cyan pigment dispersion was prepared using TRE-2 cyan pigment and the Polyurethane Dispersant described above at a pigment/dispersant ratio of 3 using the procedure described above.

### Preparation of Cross-linked Cyan Pigment Dispersion (Cyan-1 )

In the cross-linking step, a cross-linking compound is mixed with the pigmented dispersions prepared above at room temperature or elevated temperature for a period from 6 h to 8 h. To facilitate the cross-linking reaction, it may be desirable to add a catalyst. Useful catalysts can be those that are either soluble or insoluble in the liquid and can be selected depending upon the crosslinking reactions. Some suitable catalysts include DBTDL tributyl amine (“TBA”) and dimethyldodecyl amine. After the cross-linking reaction is completed, the pH of the cross-linked dispersion can be adjusted to at least about 8.0, more typically to between 8.0 and 12.0, and most typically between 8.0 and 11.0, if needed. Optionally, the dispersion may be further processed using conventional filtration procedures known in the art. The dispersions may be processed using ultrafiltration techniques that remove co-solvents and other contaminants, ions or impurities from the dispersion. The cyan pigment dispersion prepared above was cross-linked on the acid moiety with Denacol 321 to the extent of 20% molar percent.

Cyan-1 was used to prepare inks containing a defoamer and other common ink ingredients listed in Table 1 for testing.

TABLE 1

| Ingredients | Active | % by weight |
|---|---|---|
| Cyan-1 | 10.74% | 5.00% |
| 1,2-Propandiol | 100% | 5.00% |
| Glycerol | 100% | 23.00% |
| TEB | 100% | 3.00% |
| 2-Pyrrolidone/H₂O | 95% | 3.00% |
| Surfynol 465 | 100% | 0.30% |
| Proxel | 100% | 0.15% |
| KOH | 20.00% | 0.01% |
| Defoamer | | 0.05%-0.4% |
| D.I. Water | | Balance |

A total of 12 inks were prepared with Ink 1 being the control ink. The type and amount of defoamers are listed in Table 2 below. These defoamers were obtained from Air Products and Chemicals, Inc.

TABLE 2

| Inks | Defoamer | Defoamer Chemistry | Defoamer |
|---|---|---|---|
| 1 | none | | None |
| 2 | Surfynol DF75 | Oil type | 0.10% |
| 3 | Surfynol DF75 | Oil type | 0.20% |
| 4 | Surfynol PC | Acetylenic glycol type | 0.10% |
| 5 | Surfynol PC | Acetylenic glycol type | 0.20% |
| 6 | Surfynol PC | Acetylenic glycol type | 0.40% |
| 7 | Surfynol 104E | Acetylenic glycol type | 0.05% |
| 8 | Surfynol 104E | Acetylenic glycol type | 0.10% |
| 9 | Surfynol DF110L | Acetylenic glycol type | 0.40% |
| 10 | Surfynol DF 58 | Silicone | 0.10% |
| 11 | Surfynol DF 58 | Silicone | 0.20% |
| 12 | Airase 5300 | Siloxane type | 0.10% |

Inks 1-12 were subjected to a foaming test. A defoamer in an amount as listed in Table 2 was added to 40.00 grams of an ink in a 60 mL bottle. The battle was then shaken up and down vigorously 20 times, and the foam height was measured. As shown in Table 3 below, the defoamers were very effective in reducing the foaming propensity of the inks.

TABLE 3

| Ink | Foam Height (cm) |
|---|---|
| 1 (Control) | 2.9 |
| 2 | 0.4 |
| 3 | 0 |
| 4 | 1.4 |
| 5 | 1.1 |
| 6 | 0.9 |
| 7 | 0.8 |
| 8 | 0.8 |
| 9 | 0.7 |
| 10 | 0 |
| 11 | 0 |
| 12 | 1.1 |

An accelerated aging test was carried out to gauge the shelf life and robustness of the ink. A 100 g sample of each ink was transferred into a glass bottle and placed in an oven at 70° C. for 4 days before subjected to the foaming test. Results arc shown in Table 4 below.

A jetting reliability test was also carried out to gauge the ink's propensity to jet reliably from first drop to the last and not clogging the fine filters used in printhead. A 100 g sample of each ink was filtered through a 0.7 micron Whatman Glass fiber filter under house vacuum before subjecting to the foaming test. Results are shown in Table 4 below.

As shown in Table 4, Inks 4-9 containing the acetylenic type of defoamers maintained their efficiency after both the accelerated aging and jetting reliability tests.

TABLE 4

| | | Foam Height - | Foam Height - |
|---|---|---|---|
| | Foam | After Aging | After Filtration |
| Ink | Height (cm) | (cm) | (cm) |
| 1 | 2.9 | — | — |
| (Control) | | | |
| 2 | 0.4 | 0.4 | 1.4 |
| 3 | 0 | 0 | 1.3 |
| 4 | 1.4 | 1.3 | 1.7 |
| 5 | 1.1 | 0.9 | 1.1 |
| 6 | 0.9 | 0.9 | |
| 7 | 0.8 | 1.2 | 1.2 |
| 8 | 0.8 | 0.9 | 0.9 |
| 9 | 0.7 | 0.6 | |
| 10 | 0 | 0 | 1.1 |
| 11 | 0 | 0 | 1.1 |
| 12 | 1.4 | 0.5 | 2.5 |

Inks 4-6 and the control Ink 1 were also studied in a jetting test at different firing frequencies. The numbers of nozzles firing at the beginning and end of the jetting test were reported. A higher number indicated a better ink. As shown in Table 5 below, all the inks jetted very well. However, at a higher frequency (>30 KHz), the inks containing an acetylenic defoamer (Inks 4-6) were able to sustain jetting while the control ink without the defoamer (Ink 1) lost all nozzles due to clogging.

TABLE 5

| | | |
|---|---|---|
| Firing | Ink 1 | Inks 4-6 |

| frequency | Start | End | Start | End |
|---|---|---|---|---|
| 20 KHz | 10 | 10 | 10 | 10 |
| 30 KHz | 10 | 10 | 10 | 10 |
| 40 KHz | 10 | 0 | 10 | 10 |

What is claimed is:

1. An ink-jet ink composition for a high droplet ejection frequency printing system, said composition comprising an aqueous vehicle, a colorant, and an antifoaming agent; wherein said colorant is self-dispersing or dispersed by a polymeric dispersant, and said antifoaming agent is an acetylenic glycol, and wherein said acetylenic glycol is not a surfactant.

2. The ink of claim 1, wherein said ink is jetted at a frequency greater than 20 KHz.

3. The ink of claim 2, wherein said ink is jetted at a frequency greater than 30 KHz.

4. The ink of claim 1, wherein said colorant is a self-dispersing pigment.

5. The ink of claim 4, wherein said antifoaming agent is present at a concentration range of 0.05%-5% by weight, based on the total weight of ink.

6. The ink of claim 5, wherein said antifoaming agent is present at a concentration range of 0.1%-0.5% by weight, based on the total weight of ink.

7. The ink of claim 6, wherein said ink does not contain silica particulates.

8. The ink of claim 6, wherein said self-dispersing pigment is a self-dispersing carbon black pigment.

9. The ink of claim 1, wherein said colorant is a pigment dispersed by a polymeric dispersant.

10. The ink of claim 9, wherein said antifouling agent is present at a concentration range of 0.05%-5% by weight, based on the total weight of ink.

11. The ink of claim 10, wherein said antifoaming agent is present at a concentration range of 0.1%- 0.5% by weight, based on the total weight of ink.

12. An aqueous ink-jet ink and an ink-jet printer combination for printing onto a paper substrate, wherein said ink-jet ink comprises an aqueous vehicle, a colorant, and an antifoaming agent, and said ink-jet printer comprises a printhead that does not contain a filter; wherein said colorant is self-dispersing or dispersed by a polymeric dispersant, and said antifoaming agent is an acetylenic glycol, and wherein said acetylenic glycol is not a surfactant.
